(19) United States
(12) Patent Application Publication
(10) Pub. No.: US 2025/0293352 A1
(43) Pub. Date: Sep. 18, 2025

(54) SECONDARY BATTERY

(71) Applicant: Samsung SDI Co., Ltd., Yongin-si (KR)

(72) Inventor: Si Yeong Lee, Yongin-si (KR)

(73) Assignee: Samsung SDI Co., Ltd., Yongin-si (KR)

(21) Appl. No.: 18/903,571

(22) Filed: Oct. 1, 2024

(30) Foreign Application Priority Data
Mar. 13, 2024 (KR) 10-2024-0034937

(51) Int. Cl. H01M 50/105; H01M 10/0585; H01M 50/119; H01M 50/178

(52) U.S. Cl. CPC H01M 50/105; H01M 10/0585; H01M 50/119; H01M 50/178

(57) ABSTRACT

Some embodiments relate to a secondary battery, in which an electrode assembly is prevented from moving inside a first case, and when the electrode assembly is swelled, the first case is prevented from being excessively deformed. A secondary battery includes a first case, a second case configured to be disposed on the first case, and an electrode assembly positioned between the first case and the second case. At least one of the first case or the second case may include a concave part that is in contact with the electrode assembly.

### CROSS-REFERENCE TO THE RELATED APPLICATIONS

This present application claims priority to and the benefit under 35 U.S.C. § 119(a)-(d) of Korean Patent Application No. 10-2024-0034937, filed on Mar. 13, 2024, in the Korean Intellectual Property Office, the entire disclosure of which is incorporated herein by reference.

### FIELD

Aspects of embodiments of the present disclosure relate to a secondary battery.

### BACKGROUND

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments of the present disclosure provide a secondary battery in which an electrode assembly is prevented from moving inside a case, and when the electrode assembly is swelled, the case is prevented from being excessively deformed.

These and other aspects and features of the present disclosure will be described in or will be apparent from the following description of embodiments of the present disclosure.

Aspects of some embodiments of the present disclosure provide a secondary battery including: a first case; a second case configured to be disposed on the first case; and an electrode assembly positioned between the first case and the second case, wherein at least one of the first case or the second case includes a concave part in contact with the electrode assembly.

In one or more embodiments, the concave part may include a circular or linear dimple.

In one or more embodiments, the concave part may be provided in the first case and the second case.

In one or more embodiments, the concave part may be provided in areas of the first case and the second case that face each other.

In one or more embodiments, the concave part may be provided in areas of the first case and the second case that do not face each other.

In one or more embodiments, the concave part may be most concave at a center of the first case or the second case.

In one or more embodiments, the secondary battery may further include a lead tab extending outward from the electrode assembly through the first case and the second case.

In one or more embodiments, at least one of the first case or the second case may include a recess in which the electrode assembly is accommodated.

In one or more embodiments, the first case and the second case may include stainless steel.

In one or more embodiments, the first case may include a first case flange provided along a perimeter thereof; and a second case comprises a second case flange provided along a perimeter thereof, wherein the first case flange and the second case flange may be welded to each other.

In one or more embodiments, the first case and the second case may include: a first battery area extending in a first direction; and a second battery area extending in a second direction perpendicular to the first direction.

In one or more embodiments, the electrode assembly may include: a first electrode assembly area accommodated in the first battery area; and a second electrode assembly area accommodated in the second battery area.

In one or more embodiments, the concave part may be provided in the first battery area and the second battery area.

In one or more embodiments, the concave part may be provided in a perimeter of the first battery area and a perimeter of the second battery area.

In one or more embodiments, the concave part may be provided in and/or proximate to an area from which a lead tab is withdrawn and an area from which the lead tab is not withdrawn.

In one or more embodiments, the concave part may extend from the first battery area to the second battery area.

In some embodiments, the electrode assembly is sealed by the first case and the second case.

In one aspect, methods of manufacturing a secondary battery are described. In some embodiments, the method of manufacturing a secondary battery comprises providing a first case; providing a second case configured to be disposed on the first case; and positioning an electrode assembly between the first case and the second case, wherein at least one of the first case or the second case comprises a concave part in contact with the electrode assembly.

In some embodiments, the concave part comprises a circular or linear dimple.

In some embodiments, the concave part is provided in the first case and the second case.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1A illustrates a plan view of a secondary battery according to some embodiments;

FIG. 1B illustrates an exploded perspective view of the secondary battery according to some embodiments;

FIG. 1C illustrates a cross-sectional view taken along line 1C-1C of FIG. 1A, according to some embodiments;

FIG. 2 illustrates a schematic view of a state before and after swelling of the secondary battery according to some embodiments;

FIG. 3 illustrates a plan view of a secondary battery according to some embodiments;

FIG. 4 illustrates a plan view of a secondary battery according to some embodiments;

FIG. 5 illustrates a plan view of a secondary battery according to some embodiments;

FIG. 6 illustrates a plan view of a secondary battery according to some embodiments;

FIGS. 7A and 7B illustrate perspective views of a battery pack including the secondary battery according to embodiments; and

FIGS. 8A and 8B illustrate perspective and side views of a vehicle including the battery pack according to embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

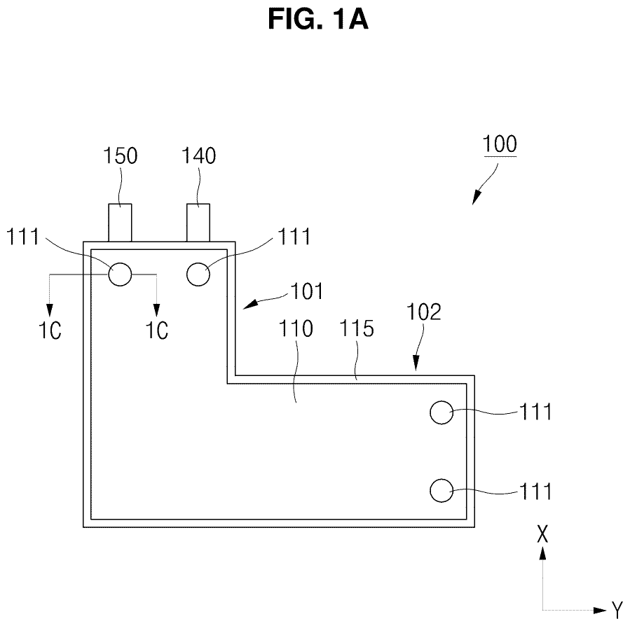

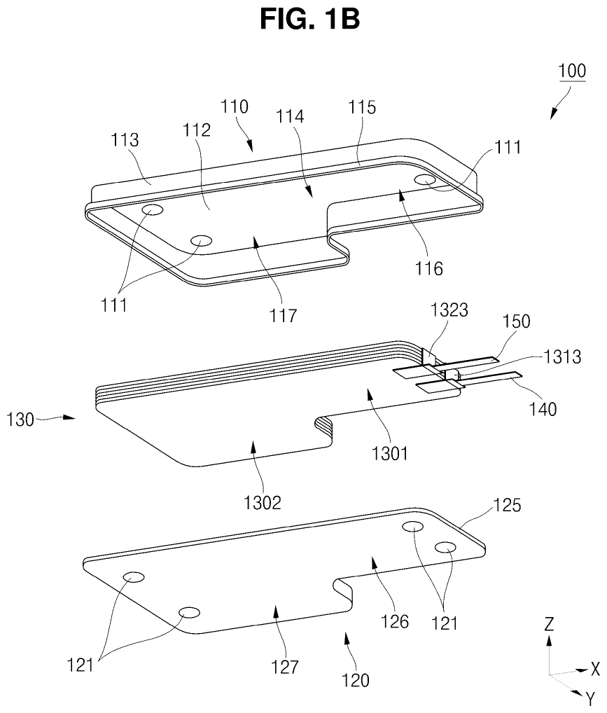

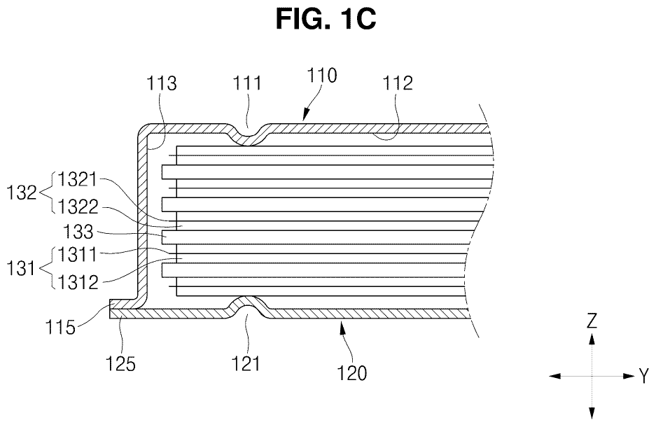

FIG. 1A illustrates a plan view of a secondary battery according to some embodiments, FIG. 1B illustrates an exploded perspective view of the secondary battery according to some embodiments, and FIG. 1C illustrates a cross-sectional view taken along line 1C-1C of FIG. 1A. As illustrated in FIGS. 1A-1C, a secondary battery 100 according to some embodiments may include a first case 110, a second case 120, and an electrode assembly 130. The secondary battery 100 according to embodiments may further include concave part(s) 111 and 121 provided in the first case 110 and/or the second case 120. In some embodiments, the secondary battery 100 according to embodiments may further include a first lead tab 140 and a second lead tab 150, which are connected to the electrode assembly and extend outward through the first case 110 and the second case 120, respectively.

The first case 110 may include a flat part (e.g., roof) 112 and a sidewall 113. The flat part 112 may be provided to be substantially flat, and the sidewall 113 may be provided to extend downward from a perimeter of the flat part 112. In one or more embodiments, a recess 114 may be defined by the flat part 112 and the sidewall 113. The first case 110 may include or be referred to as a case, a can, a pouch, an exterior, or a housing. In one or more embodiments, the first case 110 may further include a first case flange 115 that is horizontally oriented along the sidewall 113 and bent in an outward direction. In one or more embodiments, a planar shape of the first case 110 may be provided in an approximately “L” shape. In one or more embodiments, an area extending in a first direction (e.g., X direction) of the first case 110 may be defined as a first case first area 116, and an area extending in a second direction (e.g., Y direction) substantially perpendicular to the first direction may be defined as a first case second area 117. In one or more embodiments, the first case 110 may include a metal such as steel, stainless steel, nickel-plated steel, a metal such as a cold thin plate for deep drawing (SPCE) or aluminum, and/or a laminated film or plastic.

The first case 110 may include concave part(s) 111 provided in the flat part 112. The concave part 111 may protrude or be recessed toward the electrode assembly 130. An apex of the concave part 111 may be in contact with the electrode assembly 130. In one or more embodiments, the concave part 111 may be provided in a circular shape having a diameter or a linear shape having a length. In one or more embodiments, the diameter of the concave part 111 may be approximately 1 mm to approximately 100 mm. In one or more embodiments, the length of the concave part 111 may be approximately 10 mm to approximately 1,000 mm. In one or more embodiments, a depth of the concave part 111 may be approximately 1 mm to approximately 10 mm. In one or more embodiments, the concave part 111 may include or be referred to as a dimple, an embossing, a groove, or a recess. In one or more embodiments, a thickness of the concave part 111 may be similar to or equal to that of an outer area of the concave part 111. In one or more embodiments, a plurality of concave parts 111 may be provided in the flat part 112. In one or more embodiments, the concave part 111 may be provided in the first case first area 116 and/or the first case second area 117. In one or more embodiments, the concave part 111 may be provided near a perimeter of the first case first area 116 and/or near a perimeter of the first case second area 117.

The second case 120 may be provided in a generally flat shape. The second case 120 may include or be referred to as a case, a can, a pouch, an exterior, or a housing. In one or more embodiments, an area extending in a horizontal outward direction along a perimeter of the second case 120 may be defined as a second case flange 125. In one or more embodiments, a planar shape of the second case 120 may be provided in an approximately “L” shape similar to or equal to the planar shape of the first case 110. In one or more embodiments, an area extending in the first direction of the second case 120 may be defined as a second case first area 126, and an area extending in the second direction that is approximately perpendicular to the first direction may be defined as a second case second area 127. In one or more embodiments, the second case first area 126 may correspond to (e.g., overlap) the first case first area 116, and the second case second area 127 may correspond to (e.g., overlap) the first case second area 117. In one or more embodiments, the second case 120 may include a metal such as steel, stainless steel, nickel-plated steel, a metal such as a cold thin plate for deep drawing (SPCE) or aluminum, and/or a laminated film or plastic. The second case flange 125 may be coupled to the first case flange 115 to seal or accommodate the electrode assembly 130 in a space (e.g., the recess 114) between the second case 120 and the first case 110. In one or more embodiments, the second case flange 125 may be laser-welded to the first case flange 115. In one or more embodiments, the shape of the second case 120 may be similar or equal to the shape of the first case 110. In one or more embodiments, the second case 120 may include a recess defined by the flat part (e.g., bottom portion) and a sidewall.

The second case 120 may include concave part(s) 121. The concave part 121 may protrude in a direction towards the electrode assembly 130. An apex of the concave part 121 may be in contact with the electrode assembly 130. In one or more embodiments, the concave part 121 may be provided in a circular shape having a diameter or a linear shape having a length. In one or more embodiments, the concave part 121 may include or be referred to as a dimple, an embossing, a groove, or a recess. In one or more embodiments, the diameter of the concave part 121 may be approximately 1 mm to approximately 100 mm. In one or more embodiments, the length of the concave part 121 may be approximately 10 mm to approximately 1,000 mm. In one or more embodiments, a depth of the concave part 121 may be approximately 1 mm to approximately 10 mm. In one or more embodiments, a plurality of concave parts 121 may be provided in the second case 120. In one or more embodiments, the concave part 121 may be provided in the second case first area 126 and/or the second case second area 127. In one or more embodiments, the concave part 121 may be provided near a perimeter of the second case first area 126 and/or near a perimeter of the second case second area 127.

In one or more embodiments, the concave parts 111 and 121 may be provided in at least one of the first case 110 or the second case 120. In one or more embodiments, the concave parts 111 and 121 may be provided in both the first case 110 and the second case 120, respectively. In one or more embodiments, the concave parts 111 and 121 may be provided in opposing areas of the first case 110 and the second case 120. In one or more embodiments, the concave parts 111 and 121 may be provided in non-opposing areas of the first case 110 and the second case 120.

In the secondary battery 100 according to embodiments, the first case 110 and the second case 120 may be collectively referred to as a case, a can, a housing, or an exterior.

The electrode assembly 130 may be provided by stacking or winding a stack of a first electrode plate 131 and a second electrode plate 132, each of which is provided in a thin plate shape or film shape, and a separator 133 between the first and second electrode plates 131 and 132. In one or more embodiments, the electrode assembly 130 may be a Z-stack electrode assembly in which a positive electrode plate and a negative electrode plate are inserted into both sides of the separator 133 that is bent into a Z-stack. In some embodiments, the electrode assembly 130 may be accommodated or sealed in a space between the first case 110 and the second case 120 by stacking one or more electrode assemblies so that their long sides are adjacent to each other. In one or more embodiments, the first electrode plate 131 of the electrode assembly 130 may serve as a negative electrode, and the second electrode plate 132 may serve as a positive electrode, or vice versa.

The first electrode plate 131 may include a first electrode current collector plate 1311 formed of a metal foil such as copper, copper alloy, nickel, or nickel alloy. Further, the first electrode plate 131 may include a first electrode active material 1312 (or a negative electrode active material) such as graphite or carbon applied on the first electrode current collector plate 1311. Furthermore, the first electrode plate 131 may include a plurality of first electrode tabs 1313 connected to a portion of the first electrode current collector plate 1311 where the first electrode active material 1312 is not applied. In one or more embodiments, the first electrode current collector plate 1311 may be referred to as a first electrode base material, and the first electrode tab 1313 may be referred to as a first base material tab or a first non-coating portion tab. The first electrode tab 1313 may serve as a path for a current flow between the first electrode plate 131 and the first lead tab 140. In one or more embodiments, the first electrode tab 1313 may be provided by notching and/or cutting the first electrode plate 131 such that the first electrode tab 1313 protrudes to one side during manufacturing of the first electrode plate 131. In some embodiments, the first electrode tab 1313 may protrude away from the separator 133 without cutting of the first electrode plate 131.

The second electrode plate 132 may include a second electrode current collector plate 1321 made of metal foil such as aluminum or aluminum alloy. Further, the second electrode plate 132 may include a second electrode active material 1322 (positive electrode active material) such as a transition metal oxide applied on the second electrode current collector plate 1321. Furthermore, the second electrode plate 132 may include a second electrode tab 1323 connected to an area on the second electrode current collector plate 1321 where the second electrode active material 1322 is not applied. In one or more embodiments, the second electrode current collector plate 1321 may be referred to as a second electrode base material, and the second electrode tab 1323 may be referred to as a second base material tab or a second non-coating portion tab. The second electrode tab 1323 may serve as a path for a current flow between the second electrode plate 132 and the second lead tab 150. In one or more embodiments, the second electrode tab 1323 may be provided by notching or cutting the second electrode plate 132 such that the second electrode tab 1323 protrudes to the one side of the second lead tab 150 during manufacturing of the second electrode plate 131. In some embodiments, the second electrode tab 1323 may protrude in a direction away from the the separator 133 without cutting of the second electrode plate 132.

In some embodiments, the first electrode tab 1313 of the first electrode plate and the second electrode tab 1323 of the second electrode plate 132 may be disposed to be spaced apart from each other at one end of the electrode assembly 130. In one or more embodiments, the electrode assembly 130 may be accommodated in an internal space provided between the first case 110 and the second case 120 optionally with an electrolyte. In some embodiments, the plurality of first electrode tabs 1313 and the plurality of second electrode tabs 1323 may be welded and/or connected to the first lead tab 140 and the second lead tab 150, respectively.

In one or more embodiments, the first lead tab 140 and the second lead tab 150 may extend in a direction outward from the internal space provided by the first case 110 and the second case 120, respectively. The first lead tab 140 and the second lead tab 150 may also be disposed to be spaced apart from each other similarly to the first electrode tab 1313 and the second electrode tab 1323. In one or more embodiments, the first lead tab 140 may include metal foil such as copper, a copper alloy, nickel, and/or a nickel alloy. In one or more embodiments, the second lead tab 150 may include metal foil such as aluminum and/or an aluminum alloy. In one or more embodiments, a first sealing insulating tape (not shown) may be interposed between areas of the first lead tab 140 that overlaps the first case 110 and the second case 120. In some embodiments, a second sealing insulating tape (not shown) may be interposed between areas of the second lead tab 150 that overlaps the first case 110 and the second case 120.

In one or more embodiments, the planar shape of the electrode assembly 130 may be provided in an approximately “L” shape similar to or equal to the planar shape of each of the first case 110 and the second case 120. In one or more embodiments, the electrode assembly 130 may include an electrode assembly first area 1301 accommodated in an internal space between the first case first area 116 and the second case first area 126 and an electrode assembly second area 1302 accommodated in an internal space between the first case second area 117 and the second case second area 127. In one or more embodiments, the first electrode tab 1313 and the second electrode tab 1323 may be provided on the electrode assembly first area 1301. In one or more embodiments, the first case first area 116, the second case first area 126, and the electrode assembly first area 1301 may be defined as a first battery area 101, and the first case first area 116, the second case second area 127, and the electrode assembly second area 1302 may be defined as a second battery area 102.

In one or more embodiments, a separator, an insulating tape, or an insulating film may be further interposed between the electrode assembly 130 and the first case 110 to prevent electrical short-circuit between the electrode assembly 130 and the first case 110 from occurring. In one or more embodiments, a separator, an insulating tape, or an insulating film may be further interposed between the electrode assembly 130 and the second case 120 to prevent electrical short-circuit between the electrode assembly 130 and the second case 120 from occurring.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0sb≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<a<2); LiₐNi_{b}Co_{c}L1_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li(_{3-f})Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (AI) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate

The organic material may include a polyvinylidene fluoride-based heavy antibody or a (meth) acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

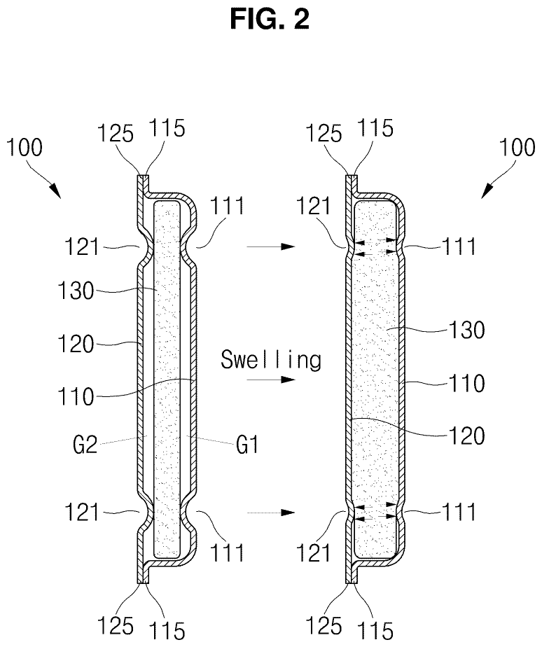

FIG. 2 illustrates a schematic view of a state before and after swelling of the secondary battery according to embodiments. As illustrated in FIG. 2, in the secondary battery 100 according to embodiments, the electrode assembly 130 may be accommodated in the internal space provided by the first case 110 and the second case 120. In some embodiments, the first case 110 and the second case 120 may include concave parts 111 and 121 facing the electrode assembly 130, respectively. In one or more embodiments, the concave part 111 of the first case 110 may be in contact with a first side of the electrode assembly 130. In one or more embodiments, the concave part 121 of the second case 120 may be in contact with a second side of the electrode assembly 130. In one or more embodiments, before swelling of the electrode assembly 130, a first gap G1 may exist between the first case 110 and the first side of the electrode assembly 130, and a second gap G2 may exist between the second case 120 and the second side of the electrode assembly 130. After the swelling of the electrode assembly 130, the first gap between the first case 110 and the first side of the electrode assembly 130 may be substantially removed and/or absent, and the second gap between the second case 120 and the second side of the electrode assembly 130 may be substantially removed and/or absent. In some embodiments, due to the swelling of the electrode assembly 130, each of the concave part 111 of the first case 110 and the concave part 121 of the second case 120 may be spread to be generally flat. In some embodiments, after the swelling of the electrode assembly 130, a depth of the concave part 111 of the first case 110 and a depth of the concave part 121 of the second case 120 may be reduced, but overall, an outer appearance of each of the first case 110 and the second case 120 may not be substantially deformed. In one or more embodiments, the secondary battery 100 may be manufactured to have a distance between the first case 110 and the second case 120 that is approximately 0.1% to approximately 20% the thickness of the electrode assembly 130. In some embodiments, as described above, a gap may be provided between the first case 110 and the first side of the electrode assembly 130 and between the second case 120 and the second side of the electrode assembly 130. However, after the manufacture of the secondary battery 100, the thickness of the electrode assembly 130 may increase due to the swelling of the electrode assembly 130 during operation of the battery. In some embodiments, the electrode assembly 130 may push the concave parts 111 and 121, which are provided in the first case 110 and the second case 120, respectively, outward such that the concave parts 111 and 121 are spread. In some embodiments, a depth of each of the concave parts 111 and 121 may decrease. In one or more embodiments, after the swelling of the electrode assembly 130, the first side of the electrode assembly 130 may be in contact with an area of the first case 110 outside the concave part 111 (e.g., a portion of the flat part 112 of the first case 110 may be in contact with the first side of the electrode assembly 130), and the second side of the electrode assembly 130 may be in contact with an area of the second case 120 outside the concave part 121 (e.g., a portion of the second case second area 127, a portion of the second case first area 126, or another portion of the second case 120 may in contact with the second side of the electrode assembly 130).

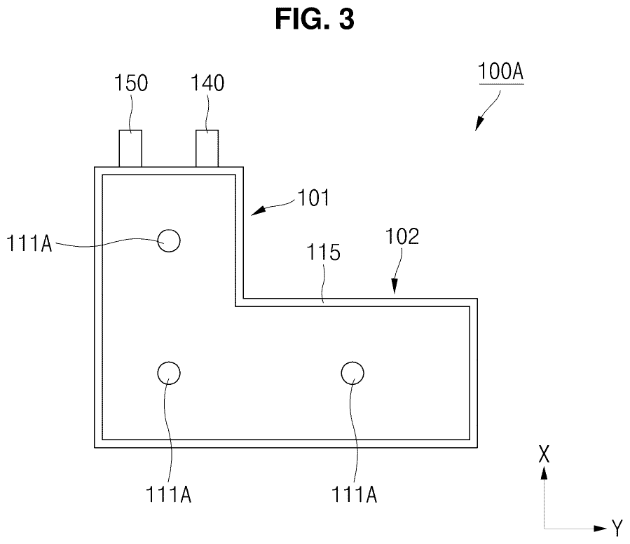

FIG. 3 illustrates a plan view of a secondary battery according to some embodiments. As illustrated in FIG. 3, an secondary battery 100A according to some embodiments may include a first battery area 101 extending in a first direction, and a second battery area 102 extending in a second direction substantially perpendicular to the first direction, and a concave part 111A may be provided in each of the first battery area 101 and the second battery area 102. In one or more embodiments, the concave part 111A may be provided at a center in a longitudinal direction of the first battery area 101, and/or the concave part 111A may be provided at a center in a longitudinal direction of the second battery area 102. While FIG. 3A depicts one concave part 111A provided in the first battery area 101, one concave part 111A provided in the second battery area 102, and/or one concave part 111A provided in a boundary area between the first and second battery areas 101 and 102, the present disclosure is not intended to be limiting in this manner, and accordingly, the secondary battery may comprise the concave part in any of a variety of quantities and/or positions.

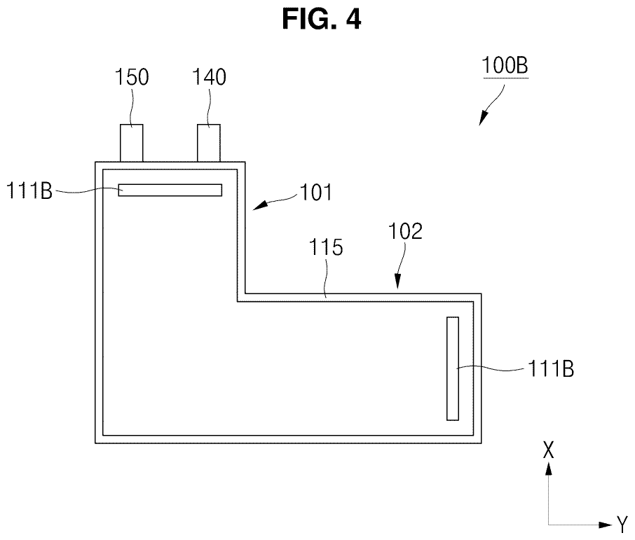

FIG. 4 illustrates a plan view of a secondary battery according to embodiments. As illustrated in FIG. 4, an secondary battery 100B according to some embodiments may include a first battery area 101 extending in a first direction, and a second battery area 102 extending in a second direction substantially perpendicular to the first direction, and a concave part 111B may be provided in each of a perimeter of the first battery area 101 and a perimeter of the second battery area 102. In one or more embodiments, a perimeter of the first battery area 101 may be adjacent to an area from which first and second lead tabs 140 and 150 protrude from the first case 110 and/or the second case 120, and a perimeter of the second battery area 102 may be an area (for example, an area from which the lead tab is not withdrawn) that is furthest from the perimeter of the first battery area 101. In one or more embodiments, the concave part 111A provided proximate to and/or within the perimeter of the first battery area 101 and the perimeter of the second battery area 102 may have a linear shape having a length.

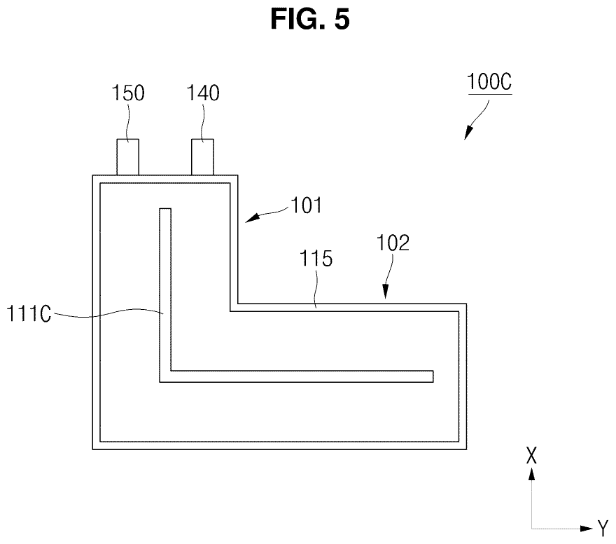

FIG. 5 illustrates a plan view of a secondary battery according to some embodiments. As illustrated in FIG. 5, an secondary battery 100C according to some embodiments may include a first battery area 101 extending in a first direction, and a second battery area 102 extending in a second direction substantially perpendicular to the first direction, and a concave part 111C may be provided from the first battery area 101 to the second battery area 102. In one or more embodiments, the concave part 111C may be provided linearly from the first battery area 101 to the second battery area 102. In one or more embodiments, the concave part 111C may be provided in an approximately “L” shape from the first battery area 101 to the second battery area 102.

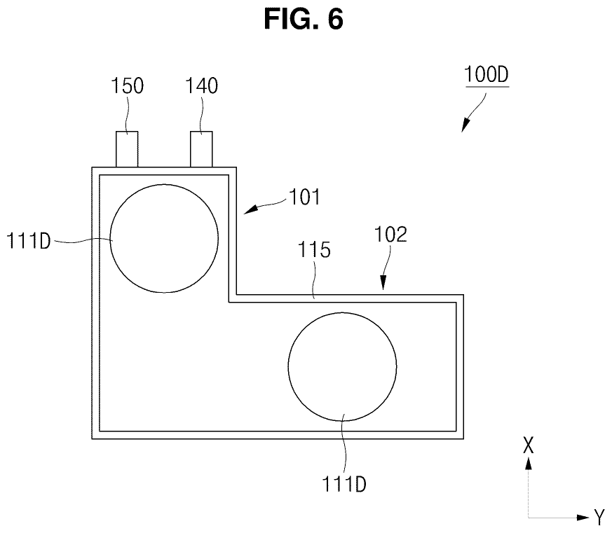

FIG. 6 illustrates a plan view of a secondary battery according to some embodiments. As illustrated in FIG. 6, an secondary battery 100D according to some embodiments may include a first battery area 101 extending in a first direction, and a second battery area 102 extending in a second direction substantially perpendicular to the first direction, and a concave part 111D may be positioned at an approximate center of the perimeter of the first battery area 101 and at an approximate center of the perimeter of the second battery area 102. In one or more embodiments, the concave part 111D of the first battery area 101 may have a diameter of approximately 50% to approximately 99% of the total width of the first battery area 101, and the concave part 111D of the second battery area 102 may have a width of approximately 50% to approximately 99% of the total width of the first battery area 101. In one or more embodiments, a depth of the concave part 111D of the first battery area 101 may be deepest at a center of the first battery area 101 and may gradually decrease toward the perimeter thereof. In one or more embodiments, a depth of the concave part 111D of the second battery area 102 may be deepest at a center of the second battery area 102 and may gradually decrease toward the perimeter thereof.

The battery according to the above-described embodiments may be used to manufacture a battery pack.

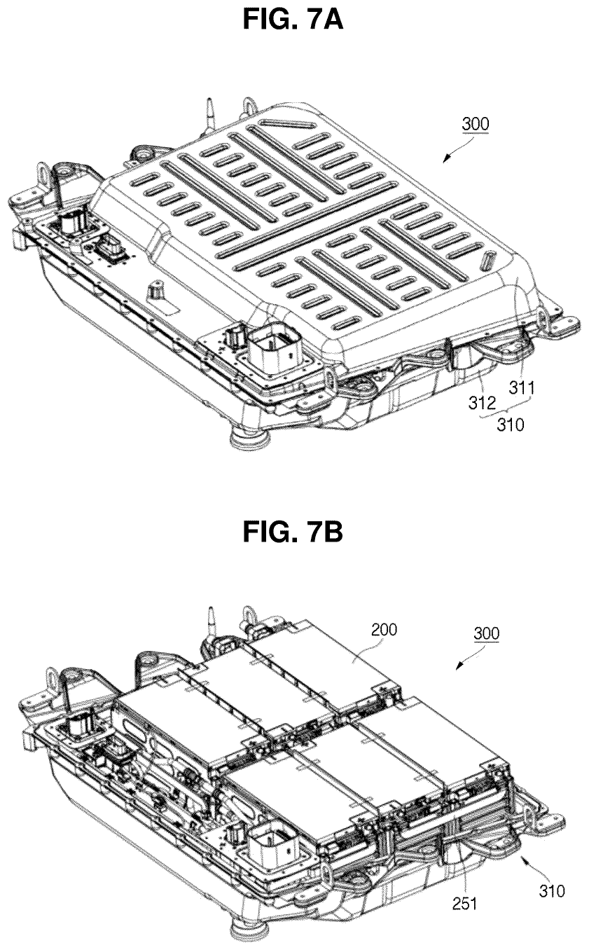

FIGS. 7A and 7B show a battery pack 300 according to one or more embodiments of the present disclosure. The battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. A vehicle may include a four-wheeled vehicle or a two-wheeled vehicle.

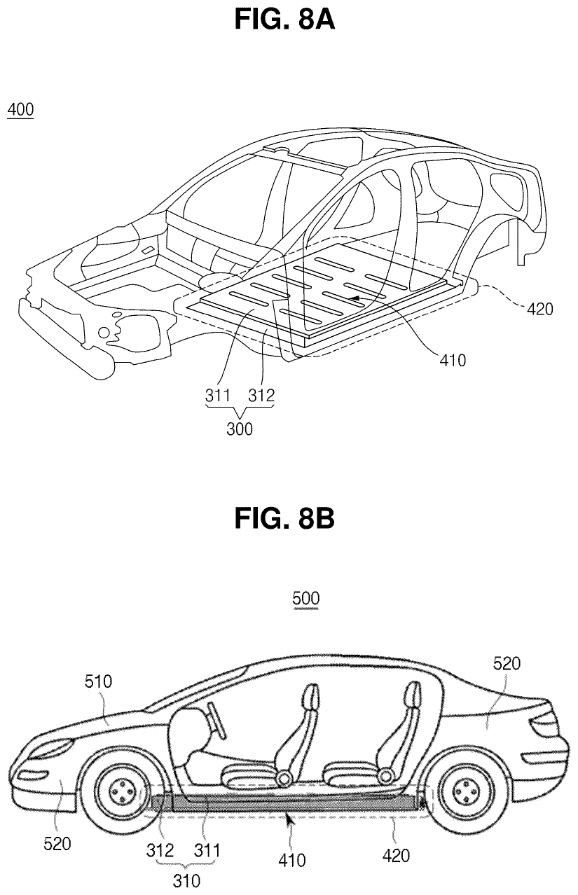

FIGS. 8A and 8B show vehicle body parts 400 and vehicle 500 according to one or more embodiments of the present disclosure including the battery pack 300 shown in FIGS. 7A and 7B.

In FIG. 8A, a battery pack 300 may include a battery pack cover 311, which is a part of a vehicle underbody 410 and may correspond to the first housing, and a pack frame 312, which is disposed under the vehicle underbody 410 and may corresponding to the second housing. The battery pack cover 311 and the pack frame 312 may be integrally formed with a vehicle floor 420. The vehicle underbody 410 separates the inside and outside of a vehicle, and the pack frame 312 may be disposed outside the vehicle.

In FIG. 8B, a vehicle 500 may be formed by combining additional parts, such as a hood 510 in front of the vehicle 500 and fenders 520 respectively located in the front and rear of the vehicle 500 to a vehicle body parts 400. The vehicle 500 may include the battery pack 300 including the battery pack cover 311 and the pack frame 312, and the battery pack 300 may be coupled to the vehicle body part 400.

The present disclosure may provide the secondary battery in which the concave part that prevents the electrode assembly from moving is provided to prevent the electrode assembly from moving inside the case. In addition, the present disclosure may provide the secondary battery in which the concave part provided in the case is spread during the swelling of the electrode assembly to prevent the outer appearance of the case from being excessively deformed.

However, aspects and features of the present disclosure are not limited to those described above, and other aspects and features not mentioned will be clearly understood by a person skilled in the art from the detailed description, described below.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery comprising:
a first case;
a second case configured to be disposed on the first case; and
an electrode assembly positioned between the first case and the second case,
wherein at least one of the first case or the second case comprises a concave part in contact with the electrode assembly.

2. The secondary battery as claimed in claim 1, wherein the concave part comprises a circular or linear dimple.

3. The secondary battery as claimed in claim 1, wherein the concave part is provided in the first case and the second case.

4. The secondary battery as claimed in claim 1, wherein the concave part is provided in areas of the first case and the second case that face each other.

5. The secondary battery as claimed in claim 1, wherein the concave part is provided in areas of the first case and the second case that do not face each other.

6. The secondary battery as claimed in claim 1, wherein the concave part is most concave at a center of the first case or the second case.

7. The secondary battery as claimed in claim 1, further comprising a lead tab extending outward from the electrode assembly through the first case and the second case.

8. The secondary battery as claimed in claim 1, wherein at least one of the first case or the second case comprises a recess in which the electrode assembly is accommodated.

9. The secondary battery as claimed in claim 1, wherein the first case and the second case comprises stainless steel.

10. The secondary battery as claimed in claim 1, wherein the first case comprises a first case flange provided along a perimeter thereof; and
a second case comprises a second case flange provided along a perimeter thereof,
wherein the first case flange and the second case flange are welded to each other.

11. The secondary battery as claimed in claim 1, wherein the first case and the second case comprise:
a first battery area extending in a first direction; and
a second battery area extending in a second direction perpendicular to the first direction.

12. The secondary battery as claimed in claim 11, wherein the electrode assembly comprises:
a first electrode assembly area accommodated in the first battery area; and
a second electrode assembly area accommodated in the second battery area.

13. The secondary battery as claimed in claim 11, wherein the concave part is provided in the first battery area and the second battery area.

14. The secondary battery as claimed in claim 11, wherein the concave part is provided in a perimeter of the first battery area and a perimeter of the second battery area.

15. The secondary battery as claimed in claim 11, wherein the concave part is provided in and/or proximate to an area from which a lead tab is withdrawn and an area from which the lead tab is not withdrawn.

16. The secondary battery as claimed in claim 11, wherein the concave part extends from the first battery area to the second battery area.

17. The secondary battery as claimed in claim 1, wherein the electrode assembly is sealed by the first case and the second case.
